(19) United States
(12) Patent Application Publication
(10) Pub. No.: US 2006/0282986 A1
(43) Pub. Date: Dec. 21, 2006

(54) Door handle for refrigerators and kitchen units

(76) Inventor: Brian S. Kim, Rancho Palos Verdes, CA (US)

Correspondence Address: PARK LAW FIRM, 3255 WILSHIRE BLVD, SUITE 1110, LOS ANGELES, CA, 90010, US

(21) Appl. No.: 11/155,853

(22) Filed: Jun. 20, 2005

(51) Int. Cl. E05B 1/00

(52) U.S. Cl. 16/412

(57) ABSTRACT

A door handle includes a base plate and a lip plate. The base plate has a front surface, a rear surface, and an edge connecting the front and rear surfaces, and the lip plate has a top surface, a bottom surface, an edge connecting the top and bottom surfaces, and a coated portion fixed on the top surface. A part of the edge of the base plate is adjacent to a part of the edge of the lip plate, and a gap is provided between the front surface of the base plate and the bottom surface of the lip plate. The lip plate partly covers the base plate allowing a hand to access the gap provided between the base plate and the lip plate. The base plate is integrated with the door of the refrigerators or the kitchen units. The door handle is substantially right triangular, rectangular, or circular.

### BACKGROUND OF THE INVENTION

The present invention relates to a door handle for refrigerators and kitchen units. More particularly, this invention relates to a door handle for refrigerators and kitchen units, which facilitates opening of the door handle by optimizing the pulling point to maximize the pulling torque. Also, the invention relates to a door handle for refrigerators and kitchen units, which increases the visibility of the door handle.

A certain amount of volume of space should be isolated or differentiated from the rest of the surrounding space in order to utilize it. The walls or cases work to that effect in refrigerators and kitchen units. That is, a refrigerator controls and keeps the temperature in the isolated space to be lower than the rest of space, and a kitchen unit makes the isolated space more suitable to store the stuffs or to encase some functions. The isolated space, however, should be eventually accessed from outside by a user. The door of the refrigerator or kitchen unit is the very channel connecting both sides of the walls or cases thereof. And, the door handle is a key to access the isolated space full of something valuable, stuffs or functions.

Even though it is a simple gadget, a door handle has non-trivial static and dynamic mechanics related to its operation including angular momentum, torque, lever, fulcrum, pressure, initial resistance, etc. Especially in the case of refrigerator in which some physical property such as temperature and pressure is sharply different on both sides of the door, the door is not that easy to open at all.

Accordingly, a need for a door handle for refrigerators or kitchen units has been present for a long time considering the possible related difficulty. This invention is directed to solve these problems and satisfy the long-felt need.

### SUMMARY OF THE INVENTION

The present invention contrives to solve the disadvantages of the prior art.

An objective of the invention is to provide a door handle for refrigerators and kitchen units.

Another objective of the invention is to provide a door handle for refrigerators and kitchen units, which facilitates opening of the door handle by optimizing the pulling point to maximize the pulling torque.

Still another objective of the invention is to provide a door handle for refrigerators and kitchen units, which increases the visibility of the door handle.

A door handle for refrigerators and kitchen units includes a base plate and a lip plate.

The base plate has a front surface, a rear surface, and an edge connecting the front and rear surfaces.

The lip plate has a top surface, a bottom surface, and an edge connecting the top and bottom surfaces, a coated portion fixed on the top surface of the lip plate.

A part of the edge of the base plate is adjacent to a part of the edge of the lip plate, and a gap is provided between the front surface of the base plate and the bottom surface of the lip plate.

The lip plate partly covers the base plate allowing a hand to access the gap provided between the front surface of the base plate and the bottom surface of the lip plate.

The front surface of the base plate is concave, and the bottom surface of the lip plate is concave or flat. The top surface of lip plate is convex or flat.

The base plate is integrated with the door of the refrigerators or the kitchen units.

The base plate is positioned at a location on the door far from the rotational axis of the door to generate a predetermined torque. The door handle is substantially right triangular. The base plate is positioned at a upper and far corner of the door, and the base part of the door handle is aligned in parallel along the top edge of the door, and the upright part of the door handle is aligned in parallel along the side edge of the door.

In another embodiment, the rim of the lip plate is closed, and the gap between the front surface of the base plate and the bottom surface of the lip plate opens in the middle of the lip plate. The lip plate is substantially L-shaped strip, covering the base and upright parts of the triangular shape. The length of the base part is about ten (10) to thirteen (13) inches, wherein the length of the upright part is about six (6) to ten (10) inches, wherein the width of the lip plate strip is about one (1) to three (3) inches. The length of the base part is eleven and a half (11½) inches, wherein the length of the upright part is eight (8) inches, wherein the width of the lip plate strip is one and five eighths (1⅝) inches.

The base plate is made of plastic, and the lip plate is made of plastic.

The coated portion comprises a metal plated film, or a silver plated film.

The advantages of the present invention are: (1) the door handle for refrigerators and kitchen units is convenient to open the door by maximizing the opening torque; (2) the door handle facilitates the visibility of the door handle by the contrast of the shape and color of the coated portion of the lip plate; (3) the door handle for refrigerators and kitchen units is convenient to open the door in refrigerators for a large capacity.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a front elevation view showing a refrigerator having a triangular door handle according to the present invention;

FIG. 2 is a front elevation view showing a refrigerator having an oval door handle;

FIG. 3 is a front elevation view showing a refrigerator having a tilted oval door handle;

FIG. 4 is a front elevation view showing a refrigerator having a L-shaped door handle;

FIG. 5 is a front elevation view showing a refrigerator with two doors having two triangular door handle;

FIG. 6 is a plan view of an enlarged triangular door handle of a first embodiment;

FIG. 7 is a plan view of an enlarged triangular door handle of a second embodiment;

FIG. 8 is a plan view of an enlarged rectangular door handle; and

FIG. 9 is a cross-sectional view along IX-IX of FIG. 8.

### DETAILED DESCRIPTION OF THE INVENTION

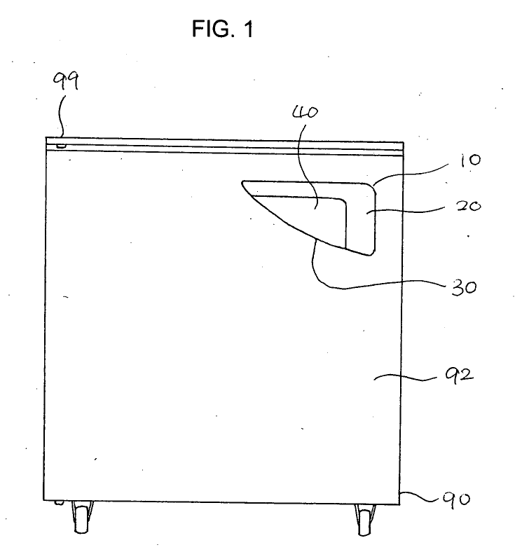

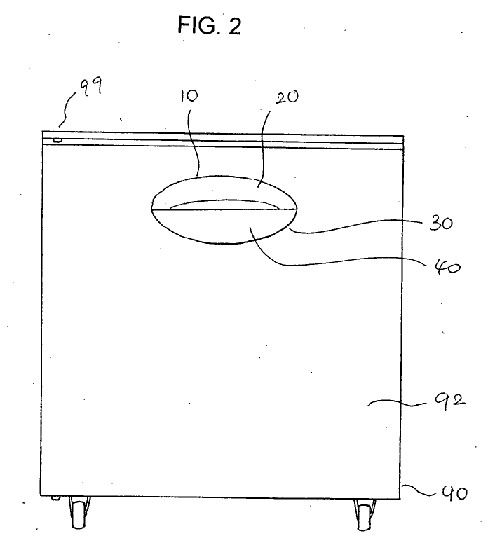

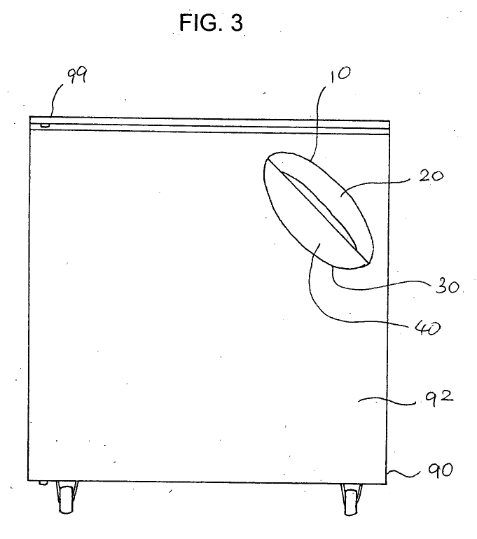

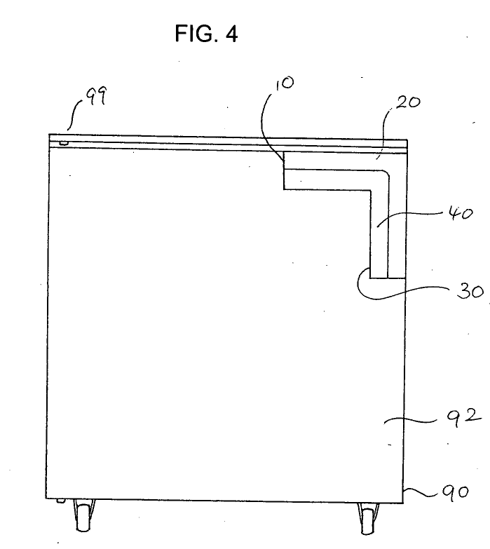

FIGS. 1 through 4 show door handles with different shapes according to the present invention.

A door handle 10 for refrigerators and kitchen units 90 includes a base plate 30 and a lip plate 20.

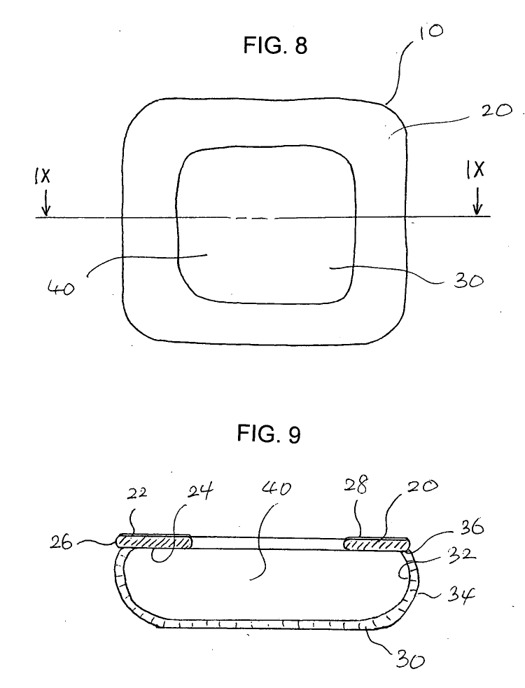

The base plate 30 has a front surface 32, a rear surface 34, and an edge 36 connecting the front and rear surfaces 32, 34 (refer to FIG. 8 and FIG. 9).

The lip plate 20 has a top surface 22, a bottom surface 24, and an edge 26 connecting the top and bottom surfaces 22, 24, a coated portion 28 fixed on the top surface 22 of the lip plate 20.

A part of the edge 36 of the base plate 30 is adjacent to a part of the edge 26 of the lip plate 20, and a gap 40 is provided between the front surface 32 of the base plate 30 and the bottom surface 24 of the lip plate 20 as shown clearly in FIG. 9.

The lip plate 20 partly covers the base plate 30 allowing a hand to access the gap 40 provided between the front surface 32 of the base plate 30 and the bottom surface 24 of the lip plate 20.

The front surface 32 of the base plate 30 is concave, and the bottom surface 24 of the lip plate 20 is concave or flat. The top surface 22 of lip plate 20 is convex or flat.

The base plate 30 may be integrated with the door 92 of the refrigerators or the kitchen units 90.

The base plate 30 is positioned at a location on the door 90 far from the rotational axis 99 of the door 90 to generate a predetermined torque. The door handle 10 is substantially right triangular as shown in FIG. 1. The base plate is positioned at an upper and far corner of the door 90, and the base part of the triangular door handle 10 is aligned in parallel along the top edge of the door 90, and the upright part of the door handle 10 is aligned in parallel along the side edge of the door 90.

In another embodiment as shown in FIG. 7 and FIG. 8, the rim of the lip plate 20 is closed, and the gap 40 between the front surface 32 of the base plate 30 and the bottom surface 24 of the lip plate 20 opens in the middle of the lip plate 20.

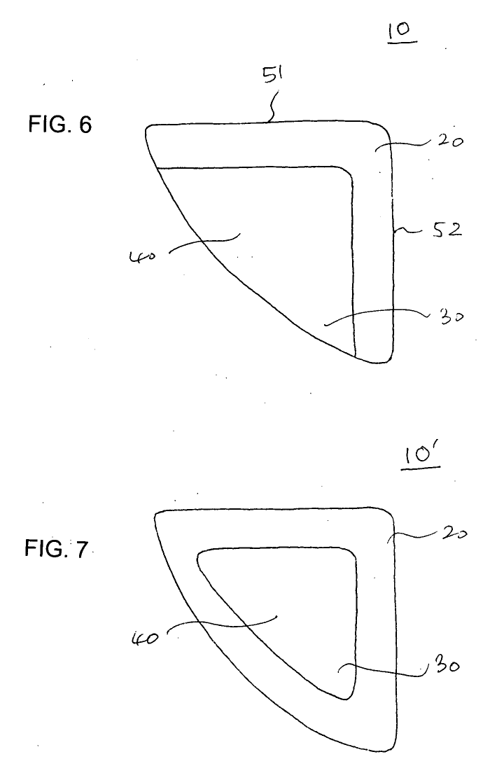

In the embodiment as shown in FIG. 6, the lip plate 20 is substantially L-shaped strip, covering the base part 51 and the upright part 52 of the triangular shape. The length of the base part 51 is about ten (10) to thirteen (13) inches, and the length of the upright part 52 is about six (6) to ten (10) inches, and the width of the lip plate strip is about one (1) to three (3) inches. More specifically, the length of the base part 51 is eleven and a half (11½) inches, and the length of the upright part 52 is eight (8) inches, and the width of the lip plate strip is one and five eighths (1⅝) inches.

The base plate 30 is made of plastic, and the lip plate 20 is made of plastic.

The coated portion 28 includes a metal plated film or a silver plated film, and the color of the coated portion 28 can be adjusted to facilitate the visibility or aesthetic quality of the surface of the coated portion 28.

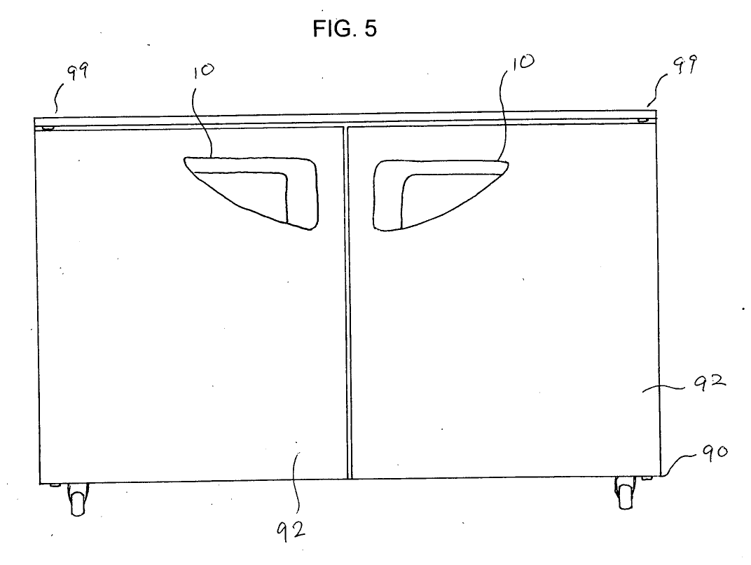

In still another embodiment as shown in FIG. 5, two or more door handles 10 can be disposed on the doors 92 of a refrigerator 90 symmetrically.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A door handle for refrigerators and kitchen units comprising:
a) a base plate having a front surface, a rear surface, and an edge connecting the front and rear surfaces; and
b) a lip plate having a top surface, a bottom surface, an edge connecting the top and bottom surfaces, and a coated portion fixed on the top surface of the lip plate,
wherein a part of the edge of the base plate is adjacent to a part of the edge of the lip plate, wherein a gap is provided between the front surface of the base plate and the bottom surface of the lip plate.

2. The door handle of claim 1, wherein the lip plate partly covers the base plate allowing a hand to access the gap provided between the front surface of the base plate and the bottom surface of the lip plate.

3. The door handle of claim 1, wherein the front surface of the base plate is concave.

4. The door handle of claim 3, wherein the bottom surface of the lip plate is concave or flat.

5. The door handle of claim 3, wherein the top surface of lip plate is convex or flat.

6. The door handle of claim 1, wherein the base plate is integrated with the door of the refrigerators or the kitchen units.

7. The door handle of claim 1, wherein the base plate is positioned at a location on the door far from the rotational axis of the door to generate a predetermined torque.

8. The door handle of claim 7, wherein the door handle is substantially right triangular.

9. The door handle of claim 8, wherein the base plate is positioned at a upper and far corner of the door, wherein the base part of the door handle is aligned in parallel along the top edge of the door, and the upright part of the door handle is aligned in parallel along the side edge of the door.

10. The door handle of claim 7, wherein the rim of the lip plate is closed, wherein the gap between the front surface of the base plate and the bottom surface of the lip plate opens in the middle of the lip plate.

11. The door handle of claim 10, wherein the lip plate is substantially L-shaped strip, covering the base and upright parts of the triangular shape.

12. The door handle of claim 11, wherein the length of the base part is about ten (10) to thirteen (13) inches, wherein the length of the upright part is about six (6) to ten (10) inches, wherein the width of the lip plate strip is about one (1) to three (3) inches.

13. The door handle of claim 12, wherein the length of the base part is eleven and a half (11½) inches, wherein the length of the upright part is eight (8) inches, wherein the width of the lip plate strip is one and five eighths (1⅝) inches.

14. The door handle of claim 1, wherein the base plate is made of plastic.

15. The door handle of claim 1, wherein the lip plate is made of plastic.

16. The door handle of claim 1, wherein the coated portion comprises a metal plated film.

17. The door handle of claim 16, wherein the coated portion comprises a silver plated film.
